(19) United States
(12) Patent Application Publication
(10) Pub. No.: US 2002/0021291 A1
(43) Pub. Date: Feb. 21, 2002

(54) Stylus with light emitting diode

(76) Inventor: Brandt A. Cook, Barberton, OH (US)

Correspondence Address: LOUIS F WAGNER, BUCKINGHAM DOOLITTLE & BURROUGHS, LLP, 50 S MAIN STREET, P O BOX 1500, AKRON, OH, 44309-1500, US

(21) Appl. No.: 09/682,958

(22) Filed: Nov. 2, 2001

Related U.S. Application Data
(60) Provisional application No. 60/278,705, filed on Mar. 26, 2001.
(60) Provisional application No. 60/285,715, filed on Apr. 23, 2001.

(51) Int. Cl. G09G 3/22

(52) U.S. Cl. 345/183

(57) ABSTRACT

The invention relates to a stylus for use with small, portable, hand-held computers typically carried by individuals to organize daily tasks and routines and to communicate with others, hereinafter generally referred to as Personal Digital Assistants (PDAs) having a light emitting diode embedded within a tip selectively operable by an end-user. The device has a cylindrical housing having a light transmissive stylus end, a light source within said light transmissive end, a battery within the housing, and a switch selectively operable to effect electrical connection between the battery and the light source.

### BACKGROUND OF INVENTION

The invention relates to a stylus for use with small, portable, hand-held computers typically carried by individuals to organize daily tasks and routines and to communicate with others, hereinafter generally referred to as Personal Digital Assistants (PDAs) having a light emitting diode (or other non-incandescent light source) embedded within a stylus tip selectively operable by an end-user.

Well-known examples of PDAs include the Apple Newton or Palm Pilot. PDAs are powerful, battery operated computers that fit in the palm of a person's hand. The typical PDA contains a microprocessor and enough memory so that it has the functionality of a general purpose computer. Typical manufacturers of PDA's are Agenda, Alcatel, Apple, Audiovox, Canon, Casio, Compaq, Diamond, Empower, Everex, Franklin, Fuga, HandEra, Handspring, Hewlett Packard, Hitachi, Husky, IBM, ltronix, JTEL, Kyocera, LG Electronics, Matsucom, MaxTech, Motorola, NEC, NTS, Neopoint, Nokia, Novatel, Oregon Scientific, Palm, Palmax, Phillips, Psion, Qualcomm, Rim, Royal, Sagem, Samsung, Sharp, Sony, Symbol, TRG, Texas Instruments, Toshiba, Trogon, Uniden, Vadem, Vtech, Xircom and others.

Even though the PDA is similar to a typical portable computer in functionality, a PDA and a portable computer are quite different in form and usage. For example, instead of a typical typewriter-style keyboard of a portable computer, the PDA has a touch sensitive screen by which to enter data and commands. Using the touch screen the user selects icons to launch certain programs or functions. While pressing icons for starting programs may be efficient and practical, the same is not true for entering text data. Pressing alphabetical letters displayed on the touch sensitive screen to form words is somewhat cumbersome and impractical. To solve this problem some PDAs utilize handwriting recognition software. Handwriting recognition software allows the user to write data on the screen thus simplifying data entry.

In the Prior Art, a pointed pen stylus is used for writing text on the screen. The pen stylus is an elongated object generally in the shape of a pen or pencil. Typically, the pen stylus is stored in an hole or slot located in the housing of the PDA. Another distinguishing feature of a PDA from a portable computer is that the display screen of a PDA is much smaller than the typical size of the display screen of a portable computer. The typical PDA display screen is a liquid crystal display (LCD). The LCD produces images by reflecting ambient light, not by producing its own light. In general, a LCD uses minimal space because it does not require the equipment to produce its own light. Furthermore, less power is consumed by the LCD. Power consumption is an important consideration with PDA's because they must contain enough battery power to allow a reasonable time of use. Since less power is required to operate the LCD, fewer batteries are needed.

Typically the PDA is preprogrammed for a specific use or vertical application uniquely designed for a specific user. Sometimes the vertical application may be the only use for which the PDA is employed. For example, a telephone company may specifically program a PDA to enable a technician in the field to make and save notes, retrieve information and perform needed calculations, during the repair of equipment. Additionally with the aid of wireless communication technology, the technician may use the PDA to communicate with a larger computer located in their vehicle or to communicate with a still larger computer located in some remote location.

The recognized utility of the PDA has resulted in a demand for its use in a variety of different environments including dark and dimly lighted environments. However, the LCD screen cannot be seen in the dark. Because the LCD screen requires ambient light to be reflected to create a image, a dark environment lacks the necessary ambient light necessary to create the reflected images on the LCD screen.

While some form of alternative display screen could be employed in PDA's, many alternative displays consume so much space within the housing of the PDA that the size of the PDA would have to be increased making awkward or inconvenient to handle. Since PDAs are designed to be small and compact, nearly every portion of available space within the PDA housing is already consumed by other equipment.

It is with respect to these and other considerations that the present invention has evolved which permits use of the PDA in either no light or dim light situations.

### SUMMARY OF INVENTION

The invention involves the incorporation of a light source into a stylus tip for use with a PDA.

It is an object of this invention to provide a light emitting diode within the transparent or translucent tip of the stylus.

It is another object of this invention to incorporate a power source within the stylus for use with the LED.

These and other objects of this invention will be evident when viewed in light of the drawings, detailed description, and appended claims.

### BRIEF DESCRIPTION OF DRAWINGS

The invention may take physical form in certain parts and arrangements of parts, a preferred embodiment of which will be described in detail in the specification and illustrated in the accompanying drawings which form a part hereof, and wherein:

FIG. 1 is a full scale elevational view of a light stylus comprising the subject of the present invention;

FIG. 2 is a greatly enlarged elevational view of the stylus shown in FIG. 1 with portions broken away and in cross-section;

FIG. 3 is an enlarged elevational view of an alternative embodiment of a stylus tip showing the combination of two parabolic geometries in different regions of the tip; and

FIG. 4 is an enlarged elevational view of an alternative embodiment of the stylus shown in FIG. 1 with portions broken away and in cross-section illustrating the incorporation of an on-off switch and the direct incorporation of a light emitting diode into the stylus tip.

### DETAILED DESCRIPTION

Referring now to the drawings wherein the showings are for purposes of illustrating the preferred embodiment of the invention only and not for purposes of limiting the same, the figures show a light stylus in accord with a preferred and alternative embodiments of the invention, suitable and adaptable for use with PDAs.

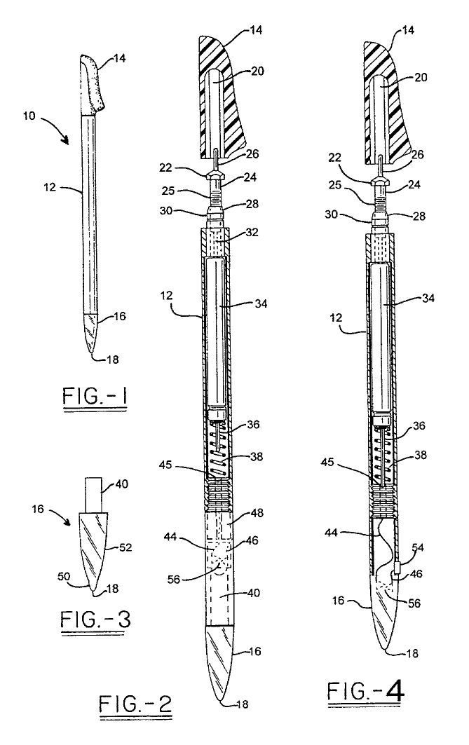

As illustrated in FIG. 1, the stylus 10 comprises a cylindrical housing 12 with an interchangeable and rotatable head 14 at one end of the housing, the head adapted for use with any specific brand of PDA and a light transmissive PDA-contacting portion 16 at an opposed end of the housing. The composition of the light transmissive portion may be a translucent polymer, or a transparent polymer, and often, will be a combination of the two. In one embodiment, the composition can be a ceramic, e.g., a composition of silica, soda ash and lime, often combined with metallic oxides to achieve various specialized properties, or as more commonly known, glass. Differences in the light transmissive characteristics of the stylus tip can be achieved by varying the composition, including but not limited to the addition of chemical additives, or by exterior etching of all or a portion of the stylus or combinations of both physical and compositional means. As used in this application, light transmissive means a substrate through which at least some light is capable of passing through, i.e., not completely opaque or totally light absorbing.

As better illustrated in FIG. 3 as one embodiment, the PDA-contacting portion 16 is comprised of a transparent portion 50 adjacent to the tip 18 and a translucent portion 52 above the transparent portion. When employed in this combination configuration, the “halo” effect is minimized. In yet another embodiment of the invention, not only is the tip comprised of transparent and translucent polymeric sections, but the geometry associated with each polymer component of the tip is based on a different parabolic equation when viewed the tip is viewed in cross-section. The parabolic shape of the transparent component 50 of the tip in cross-section has steeper sides when compared with the parabolic curve of the translucent component 52 of the tip. While the ability to have different polymers with varying light transmissive characteristics is described, there is no need to limit the invention to such, and it is within the scope of the invention to have tips comprised of one or more polymers and/or polymer blends to be used as the PDA-contacting portion.

As illustrated in FIG. 2, the stylus has a removable and interchangeable head 14 for use with specific models of PDAs. The head has an internal bore 20 disposed at least partially therethrough and dimensioned to permit frictional penetration of a cylindrical projection 26 longitudinally and axially projecting from a nut 22 having an opposed threaded male projection 24 for mating engagement with a correspondingly threaded female receiving extension 30, said extension having a collar 28 and a threaded cylindrical bore disposed therethrough and fixedly attached to one distal end of said housing 12. Projection 26 is dimensioned so as to be capable of functioning as a reset tool for the PDA. Upon clockwise rotational movement of nut 22, the threaded engagement of the screw flights 25 in mating association with the female grooves effect axial longitudinal movement of the male projection 24 toward the proximal end of the housing, thereby effecting contacting engagement of said screw flights 25 with a power source, e.g., a cylindrical battery 34, disposed within the distal end of the housing bore. With continued clockwise rotational movement, the threaded male projection continues to effect longitudinal axial movement and forcing corresponding axial movement of the battery within the housing toward the proximal end of the housing. The battery is typically biased toward the distal end of the housing by a biasing means 38, e.g., a spring. In one embodiment of the invention, the outer housing of the battery serves as the anode, while a center pole emanating from one end of the battery serves as a cathode 36.

Still further rotational movement of nut 22 permits the battery cathode 36 to engage a metallic sleeve 45 within a circular housing 48 in electrical contact with one 44 of the two leads 44, 46 of the light emitting diode (LED) 56 positioned within the housing. Upon making electrical contact with one of the LED leads, the circuit is completed as the housing 12 is in electrical contact with the second lead 46, and the LED 56 emits light at a desired wavelength, said light focused toward a stylus tip 18 through communication with a transparent male projection 40 of said light transmissive PDA-contacting portion 16.

Interposed between the PDA-contacting portion and the battery cathode 36, is a cylindrical circuit means 48 having a centrally disposed bore therethrough for mating engagement with the tip of the battery cathode 36 and one of the leads from the LED. Within at least a portion of the circuit means is a copper or brass inner sleeve with a biasing means at a distal end to facilitate the reverse engagement of the battery cathode lead from the circuit means in cooperation with the main biasing means 38. A second LED lead 46 is in electrical contact with the metallic housing thereby completing the circuit.

As illustrated in FIG. 4, alternatives are envisioned to rotational activation of the light emitting diode, e.g., a selectively positionable on/off switch 54. It is easily recognized that this switch could be a push button type switch or even a switch which is activated by the application of pressure to the stylus. While the location of the switch is shown toward the proximal end, there is no reason to limit the location to such, and it is equally envisioned that the switch could be positioned at the distal end, or even at a location between the proximal and distal ends of the cylindrical housing. In the embodiment shown in FIG. 4, the LED is encased within the light transmissive end of the stylus, and contacting engagement with the PDA is made by the encasing polymer for the LED. There is no need for a separable PDA-contacting portion as shown in FIG. 3 where the LED is contained within the housing.

The battery used in this invention is that of commonly used watch-type batteries, e.g., capable of delivering 300 milliamps at 3 volts although it is easily recognized by those skilled in the art that a balancing of the battery duration and power drain by the LED are at issue, coupled with the desired luminosity of the emitted light.

One of the features of this stylus resides in the recognition that LEDs have unique characteristics in comparison to traditional incandescent light bulbs, the technology for which has changed little this past century. Electrical current passing through a thin ware in a glass vacuum bulb causes the wire to burn and give off light, much of the energy being wasted as radiated heat, the same heat which eventually destroys the wire itself, causing the bulb to fail. Even when the glass bulb is in tact, the filaments in the bulbs are also susceptible to shock and may break if dropped.

LEDs have built-in micro-sized reflectors, designed into the LED to have a particular degree projection field, typically 15-90 degrees. This eliminates the need for external reflectors, enhancing the LED's ability to be built into small, efficient housings. In converting electricity to light, negatively charged electrons travel across an area in the LED known as the positive-negative junction or “p-n” junction. These negative electrons are attracted to the positively charged electron holes on the other side of the junction. When they bond, a small amount of energy is given off in the form of visible light, one photon for each occurring bond. Heat is not part of the equation, so an LED doesn't “burn out.” LEDs are diodes, a type of semiconductor device. In their simplest form, these diodes consist of a sandwich of two layers of material. Each layer is mixed with impurities to give it opposite electrical properties, an excess of electrons or of positive charge-carriers called holes. Passing current through such a device forces the electrons and holes into the junction between the two layers. There, they pair off and emit an photon, i.e., light. In a light emitting diode, each electron that arrives in the p-type semiconductor after crossing the p-n junction recombines with an electron hole in a remarkable way, it gives up its extra energy as light. Each time an electron and an electron hole recombine, they emit one particle of light, a photon, and the frequency, wavelength, and color of that light depends on the amount of energy given up by the electron as it falls into the electron hole. The semiconductor material from which an LED is made has a characteristic called its bandgap. This band gap measure the energy needed to pull an electron away from an electron hole in the material. If this band gap is small, the LED will emit infrared light. If this band gap is larger, the LED will emit red, orange, yellow, green, or even blue light. Because each electron loses more energy in recombining with an electron hole in an LED that it would in a normal diode, the current flowing through an LED loses more voltage (typically 2 volts for red LEDs and as much as 4 volts for blue LEDs) than does the current flowing through a regular diode (typically 0.6 volts).

Recent developments of large band gap semiconductors have made blue LEDs possible. It is also possible to obtain a “white” LED. This device is actually a blue LED, combined with a fluorescent phosphor that converts the blue light into white light.

LEDs that emit more than one color are actually two different LEDs connected to a single circuit in opposite directions. When current flows in one direction around that circuit, one of the LEDs emits light. When the current reverses directions, the other LED emits light. And when the current reverses directions rapidly, both LEDs emit light alternately. If one LED emits red light and the other green light, then the overall device will appear yellow or orange when they are bot operating alternatively in rapid sequence. The amount of light that an LED emits depends on the current flowing through it, the more electrons that are falling into holes in the p-type semiconductor, the more light that is being emitted. However, many devices that use LEDs just turn them on or off because that's easier than controlling the current flowing through them.

Light Emitting Diodes (LEDs) are available in various configurations, which are capable of projecting light of various colors. For example, LED types can be classified as emitting light in the infrared range, visible light range 780 nm-380 nm (e.g., red, orange, yellow, green, turquoise, white and blue and combinations thereof) as well as in the ultraviolet range. Even though it requires more energy to power LEDs which emit light in the white, turquoise and blue area of the band than in the other areas of the band, these LEDs still only use 5-10% of the power of “equivalent” light bulbs. Red, orange, yellow and green LEDs may use as little as approximately 1% of the energy required to power their light bulb counterparts.

This invention has been described in detail with reference to specific embodiments thereof, including the respective best modes for carrying out each embodiment. It shall be understood that these illustrations are by way of example and not by way of limitation.

1. A device which comprises:
(a) a housing having opposed ends;
(b) a light emitting diode light source at a light transmissive end;
(c) a battery within the housing; and
(d) a circuit completing means to selectively effect electrical connection between the battery and the light source.

2. The device of claim 1 wherein
(a) said circuit completing means is a switch.

3. The device of claim 2 wherein
(a) said light transmissive stylus end is selected from the group consisting of transparent and translucent polymers.

4. The device of claim 3 wherein
(a) said light transmissive stylus end has a parabolic curvature.

5. The device of claim 4 wherein
(a) said light transmissive stylus end has two parabolic curvatures.

6. The device of claim 5 wherein
(a) a first of said two parabolic curvatures is associated with a transparent parabolic curvature, and
(b) a second of said two parabolic curvatures is associated with a translucent parabolic curvature.

7. A device which comprises:
(a) a housing having a light transmissive stylus end;
(b) a light emitting diode at said light transmissive end;
(c) a battery within the housing; and
(d) a circuit completing means to selectively effect electrical connection between the battery and the light source.

8. The device of claim 7 wherein
(a) said circuit completing means is a switch.

9. The device of claim 8 wherein
(a) said light transmissive stylus end is selected from the group consisting of transparent and translucent polymers.

10. The device of claim 9 wherein
(a) said light transmissive stylus end has a parabolic curvature.

11. The device of claim 10 wherein
(a) said light transmissive stylus end has two parabolic curvatures.

12. The device of claim 11 wherein
(a) a first of said two parabolic curvatures is associated with a transparent parabolic curvature, and
(b) a second of said two parabolic curvatures is associated with a translucent parabolic curvature.

13. A device which comprises:
(a) a housing having a light transmissive stylus end;
(b) a light emitting diode adjacent said light transmissive end;
(c) a battery within the housing; and
(d) a switch selectively operable to effect electrical connection between the battery and the light source.

14. The device of claim 13 wherein
(a) said circuit completing means is a switch.

15. The device of claim 14 wherein
(a) said light transmissive stylus end is selected from the group consisting of transparent and translucent polymers.

16. The device of claim 15 wherein
(a) said light transmissive stylus end has a parabolic curvature.

17. The device of claim 16 wherein
(a) said light transmissive stylus end has two parabolic curvatures.

18. The device of claim 17 wherein
(a) a first of said two parabolic curvatures is associated with a transparent parabolic curvature, and
(b) a second of said two parabolic curvatures is associated with a translucent parabolic curvature.

19. A device which comprises:
(a) a housing having a light transmissive stylus end;
(b) a light emitting diode in said light transmissive end;
(c) a battery within the housing; and
(d) a switch selectively operable to effect electrical connection between the battery and the light source.

20. The device of claim 19 wherein
(a) said circuit completing means is a switch.

21. The device of claim 20 wherein
(a) said light transmissive stylus end is selected from the group consisting of transparent and translucent polymers.

22. The device of claim 21 wherein
(a) said light transmissive stylus end has a parabolic curvature.

23. The device of claim 22 wherein
(a) said light transmissive stylus end has two parabolic curvatures.

24. The device of claim 23 wherein
(a) a first of said two parabolic curvatures is associated with a transparent parabolic curvature, and
(b) a second of said two parabolic curvatures is associated with a translucent parabolic curvature.

25. A device which comprises:
(a) a housing having a light transmissive stylus end;
(b) a light emitting diode at said light transmissive end, wherein said light transmissive end is selected from the group consisting of transparent and translucent polymers;
(c) a battery within the housing; and
(d) an electrical circuit completing means selectively operable to effect electrical connection between the battery and the light source.

26. The device of claim 25 wherein
(a) said circuit completing means is a switch selected from the group consisting of a sliding on/off switch, a push button switch and a pressure transducer switch.

27. The device of claim 26 wherein
(a) said light transmissive stylus end has a parabolic curvature.

28. The device of claim 27 wherein
(a) said light transmissive stylus end has two parabolic curvatures.

29. The device of claim 28 wherein
(a) a first of said two parabolic curvatures is associated with a transparent parabolic curvature, and
(b) a second of said two parabolic curvatures is associated with a translucent parabolic curvature.

30. A device which comprises:
(a) a housing having a light transmissive stylus end;
(b) a light emitting diode within said light transmissive end, wherein said light transmissive end is selected from the group consisting of transparent and translucent polymers;
(c) a battery within the housing; and
(d) a switch selectively operable to effect electrical connection between the battery and the light source.

31. The device of claim 30 wherein
(a) said circuit completing means is a switch selected from the group consisting of a sliding on/off switch, a push button switch and a pressure transducer switch.

32. The device of claim 31 wherein
(a) said light transmissive stylus end has a parabolic curvature.

33. The device of claim 32 wherein
(a) said light transmissive stylus end has two parabolic curvatures.

34. The device of claim 33 wherein
(a) a first of said two parabolic curvatures is associated with a transparent parabolic curvature, and
(b) a second of said two parabolic curvatures is associated with a translucent parabolic curvature.
